(19) United States
(12) Patent Application Publication
(10) Pub. No.: US 2025/0300778 A1
(43) Pub. Date: Sep. 25, 2025

(54) ORDERING NON-ZERO COEFFICIENTS FOR COHERENT JOINT TRANSMISSION PRECODING

(71) Applicant: QUALCOMM Incorporated, San Diego, CA (US)

(72) Inventors: Min HUANG, Beijing (CN); Jing DAI, Beijing (CN); Hao XU, Beijing (CN)

(21) Appl. No.: 18/869,685

(22) PCT Filed: Jul. 14, 2022
(86) PCT No.: PCT/CN2022/105619

§ 371 Date: Nov. 26, 2024

(51) Int. Cl. H04L 5/00; H04B 7/024; H04W 72/21

(52) U.S. Cl. CPC H04L 5/0035; H04B 7/024; H04W 72/21

(57) ABSTRACT

Various aspects of the present disclosure generally relate to wireless communication. In some aspects, a user equipment (UE) may determine a set of non-zero coefficients (NZCs) that are associated with coherent joint transmission (CJT) and multiple transmit-receive points (TRPs) of a network. Accordingly, the UE may transmit uplink control information (UCI) indicating at least a portion of the set of NZCs ordered according to an order of the associated TRPs. Alternatively, the UE may transmit UCI indicating at least a portion of the set of NZCs ordered according to an order of frequency bases for the set of NZCs. Numerous other aspects are described.

### FIELD OF THE DISCLOSURE

Aspects of the present disclosure generally relate to wireless communication and to techniques and apparatuses for ordering non-zero coefficients for coherent joint transmission precoding.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include determining a set of non-zero coefficients (NZCs) that are associated with coherent joint transmission (CJT) and multiple transmit-receive points (TRPs) of a network. The method may include transmitting uplink control information (UCI) indicating at least a portion of the set of NZCs ordered according to an order of the associated TRPs.

Some aspects described herein relate to a method of wireless communication performed by a network entity. The method may include receiving UCI indicating at least a portion of a set of NZCs, associated with multiple TRPs, ordered according to an order of the associated TRPs. The method may include performing CJT precoding based on the portion of the set of NZCs.

Some aspects described herein relate to a method of wireless communication performed by a UE. The method may include determining a set of NZCs that are associated with CJT and multiple TRPs of a network. The method may include transmitting UCI indicating at least a portion of the set of NZCs ordered according to an order of frequency bases for the set of NZCs.

Some aspects described herein relate to a method of wireless communication performed by a network entity. The method may include receiving UCI indicating at least a portion of a set of NZCs, associated with multiple TRPs, ordered according to an order of frequency bases for the set of NZCs. The method may include performing CJT precoding based on the portion of the set of NZCs.

Some aspects described herein relate to an apparatus for wireless communication at a UE. The apparatus may include a memory and one or more processors coupled to the memory. The one or more processors may be configured to determine a set of NZCs that are associated with CJT and multiple TRPs of a network. The one or more processors may be configured to transmit UCI indicating at least a portion of the set of NZCs ordered according to an order of the associated TRPs.

Some aspects described herein relate to an apparatus for wireless communication at a network entity. The apparatus may include a memory and one or more processors coupled to the memory. The one or more processors may be configured to receive UCI indicating at least a portion of a set of NZCs, associated with multiple TRPs, ordered according to an order of the associated TRPs. The one or more processors may be configured to perform CJT precoding based on the portion of the set of NZCs.

Some aspects described herein relate to an apparatus for wireless communication at a UE. The apparatus may include a memory and one or more processors coupled to the memory. The one or more processors may be configured to determine a set of NZCs that are associated with CJT and multiple TRPs of a network. The one or more processors may be configured to transmit UCI indicating at least a portion of the set of NZCs ordered according to an order of frequency bases for the set of NZCs.

Some aspects described herein relate to an apparatus for wireless communication at a network entity. The apparatus may include a memory and one or more processors coupled to the memory. The one or more processors may be configured to receive UCI indicating at least a portion of a set of NZCs, associated with multiple TRPs, ordered according to an order of frequency bases for the set of NZCs. The one or more processors may be configured to perform CJT precoding based on the portion of the set of NZCs.

Some aspects described herein relate to a non-transitory computer-readable medium that stores a set of instructions for wireless communication by a UE. The set of instructions, when executed by one or more processors of the UE, may cause the UE to determine a set of NZCs) that are associated with CJT and multiple TRPs of a network. The set of instructions, when executed by one or more processors of the UE, may cause the UE to transmit UCI indicating at least a portion of the set of NZCs ordered according to an order of the associated TRPs.

Some aspects described herein relate to a non-transitory computer-readable medium that stores a set of instructions for wireless communication by a network entity. The set of instructions, when executed by one or more processors of the network entity, may cause the network entity to receive UCI indicating at least a portion of a set of NZCs, associated with multiple TRPs, ordered according to an order of the associated TRPs. The set of instructions, when executed by one or more processors of the network entity, may cause the network entity to perform CJT precoding based on the portion of the set of NZCs.

Some aspects described herein relate to a non-transitory computer-readable medium that stores a set of instructions for wireless communication by an UE. The set of instructions, when executed by one or more processors of the UE, may cause the UE to determine a set of NZCs that are associated with CJT and multiple TRPs of a network. The set of instructions, when executed by one or more processors of the UE, may cause the UE to transmit UCI indicating at least a portion of the set of NZCs ordered according to an order of frequency bases for the set of NZCs.

Some aspects described herein relate to a non-transitory computer-readable medium that stores a set of instructions for wireless communication by a network entity. The set of instructions, when executed by one or more processors of the network entity, may cause the network entity to receive UCI indicating at least a portion of a set of NZCs, associated with multiple TRPs, ordered according to an order of frequency bases for the set of NZCs. The set of instructions, when executed by one or more processors of the network entity, may cause the network entity to perform CJT precoding based on the portion of the set of NZCs.

Some aspects described herein relate to an apparatus for wireless communication. The apparatus may include means for determining a set of NZCs that are associated with CJT and multiple TRPs of a network. The apparatus may include means for transmitting UCI indicating at least a portion of the set of NZCs ordered according to an order of the associated TRPs.

Some aspects described herein relate to an apparatus for wireless communication. The apparatus may include means for receiving UCI indicating at least a portion of a set of NZCs, associated with multiple TRPs, ordered according to an order of the associated TRPs. The apparatus may include means for performing CJT precoding based on the portion of the set of NZCs.

Some aspects described herein relate to an apparatus for wireless communication. The apparatus may include means for determining a set of NZCs that are associated with CJT and multiple TRPs of a network. The apparatus may include means for transmitting UCI indicating at least a portion of the set of NZCs ordered according to an order of frequency bases for the set of NZCs.

Some aspects described herein relate to an apparatus for wireless communication. The apparatus may include means for receiving UCI indicating at least a portion of a set of NZCs, associated with multiple TRPs, ordered according to an order of frequency bases for the set of NZCs. The apparatus may include means for performing CJT precoding based on the portion of the set of NZCs.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment in a wireless network, in accordance with the present disclosure.

FIG. 3 is a diagram illustrating an example disaggregated base station architecture, in accordance with the present disclosure.

FIG. 4A is a diagram illustrating an example of joint frequency domain coherent joint transmission (CJT) precoding, in accordance with the present disclosure.

FIG. 4B is a diagram illustrating an example of separate frequency domain CJT precoding, in accordance with the present disclosure.

FIG. 5A is a diagram illustrating an example associated with non-zero coefficient (NZC) ordering for a semi-separate codebook, in accordance with the present disclosure.

FIG. 5B is a diagram illustrating an example associated with NZC ordering for a joint codebook, in accordance with the present disclosure.

FIG. 6 is a diagram illustrating an example associated with permutating frequency domain bases, in accordance with the present disclosure.

FIG. 7A is a diagram illustrating an example associated with NZC ordering for a semi-separate codebook, in accordance with the present disclosure.

FIG. 7B is a diagram illustrating an example associated with NZC ordering for a joint codebook, in accordance with the present disclosure.

FIG. 8 is a diagram illustrating an example associated with NZC ordering for a joint codebook, in accordance with the present disclosure.

FIGS. 9, 10, 11, and 12 are diagrams illustrating example processes associated with ordering NZCs for CJT precoding, in accordance with the present disclosure.

FIGS. 13 and 14 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

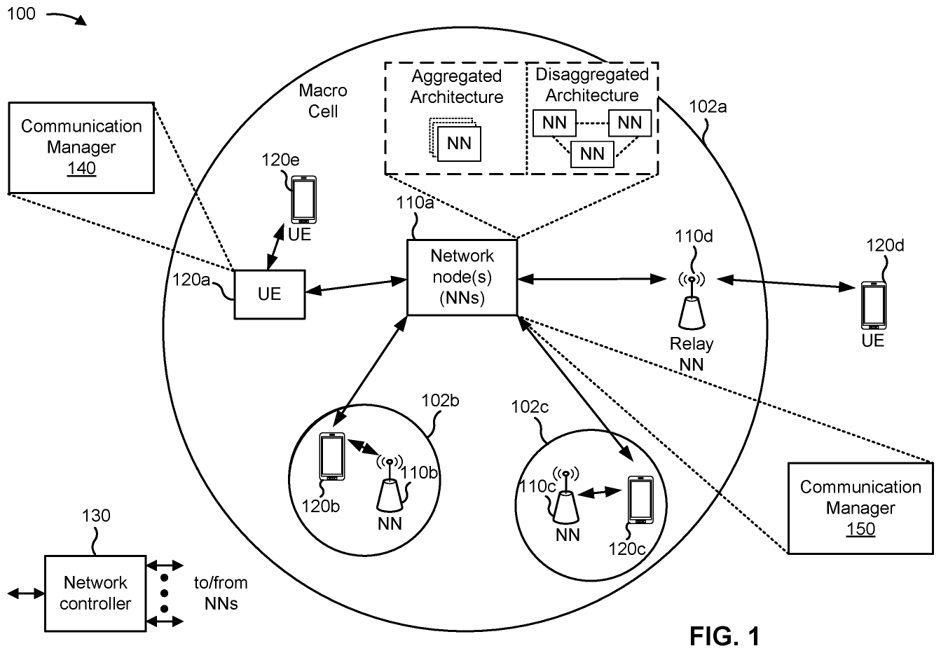

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE 120 may include a communication manager 140. As described in more detail elsewhere herein, the communication manager 140 may determine a set of non-zero coefficients (NZCs) that are associated with coherent joint transmission (CJT) and multiple transmit-receive points (TRPs) of a network and may transmit uplink control information (UCI) indicating at least a portion of the set of NZCs ordered according to an order of the associated TRPs. Alternatively, the communication manager 140 may determine a set of NZCs that are associated with CJT and multiple TRPs of a network and may transmit UCI indicating at least a portion of the set of NZCs ordered according to an order of frequency bases for the set of NZCs. Additionally, or alternatively, the communication manager 140 may perform one or more other operations described herein.

In some aspects, a network entity 110 may include a communication manager 150. As described in more detail elsewhere herein, the communication manager 150 may receive UCI indicating at least a portion of a set of NZCs, associated with multiple TRPs, ordered according to an order of the associated TRPs and may perform CJT precoding based on the portion of the set of NZCs. Alternatively, the communication manager 150 may receive UCI indicating at least a portion of a set of NZCs, associated with multiple TRPs, ordered according to an order of frequency bases for the set of NZCs and may perform CJT precoding based on the portion of the set of NZCs. Additionally, or alternatively, the communication manager 150 may perform one or more other operations described herein.

As indicated above, FIG. 1 is provided as an example. Other examples may differ from what is described with regard to FIG. 1.

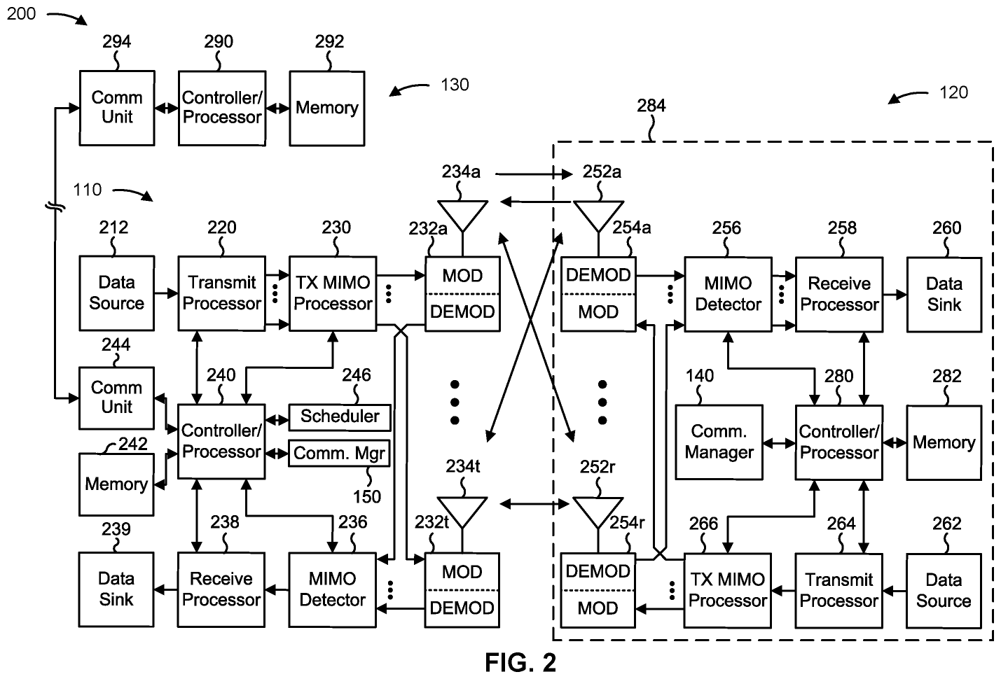

FIG. 2 is a diagram illustrating an example 200 of a network node 110 in communication with a user equipment (UE) 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

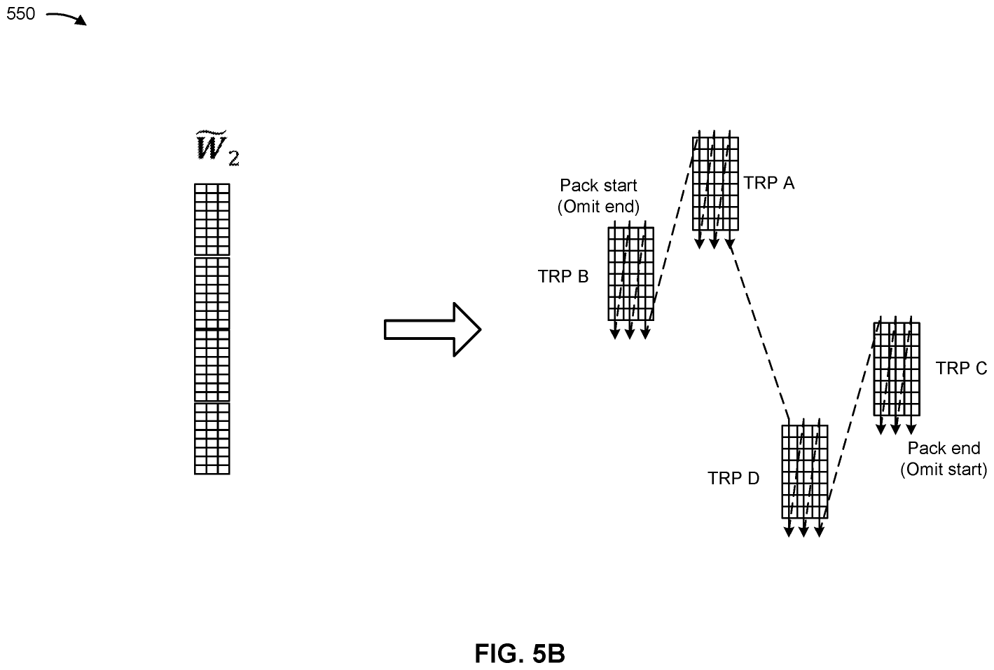

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5A, 5B, 6, 7A, 7B, and 8-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5A, 5B, 6, 7A, 7B, and 8-14).

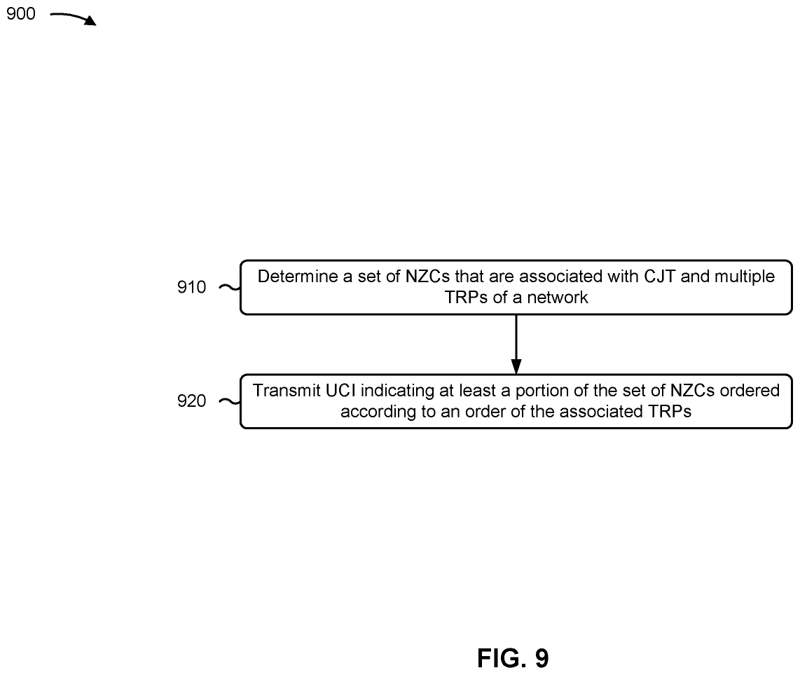

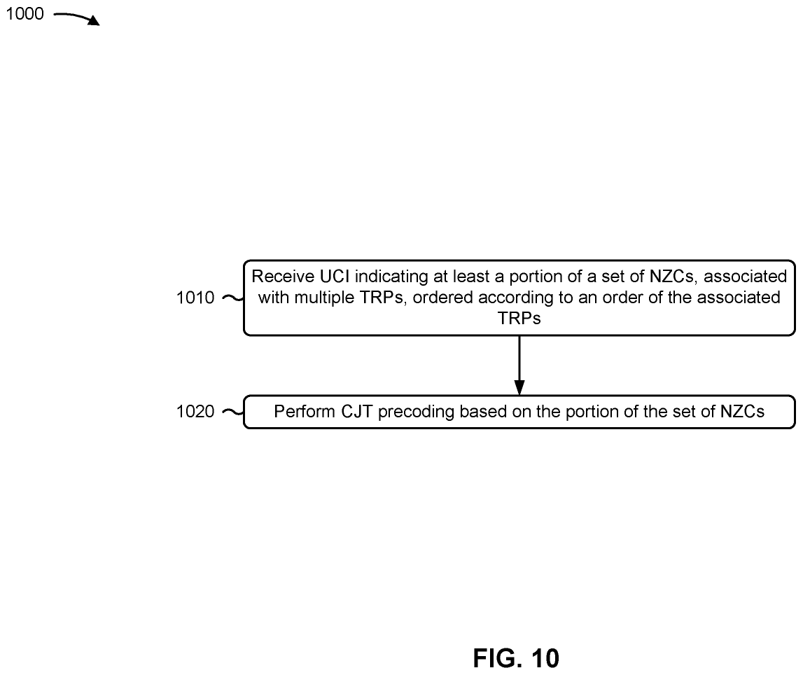

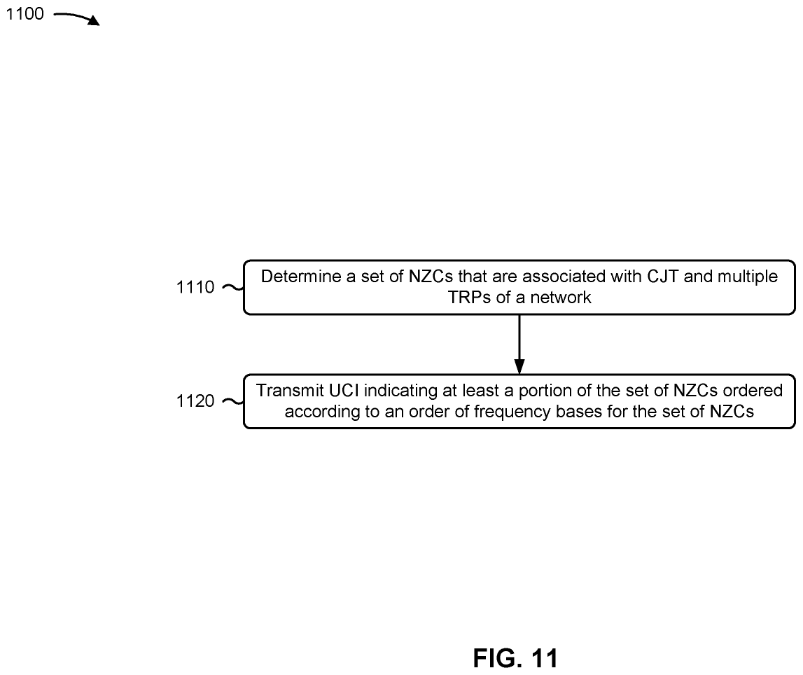

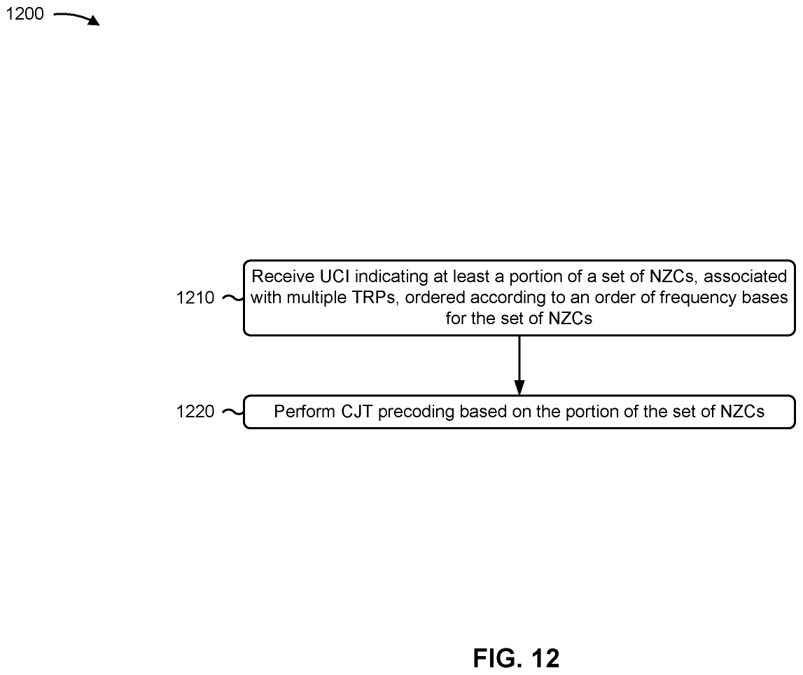

The controller/processor 240 of the network node 110, the controller/processor 280 of the UE 120, and/or any other component(s) of FIG. 2 may perform one or more techniques associated with ordering NZCs for CJT precoding, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples.

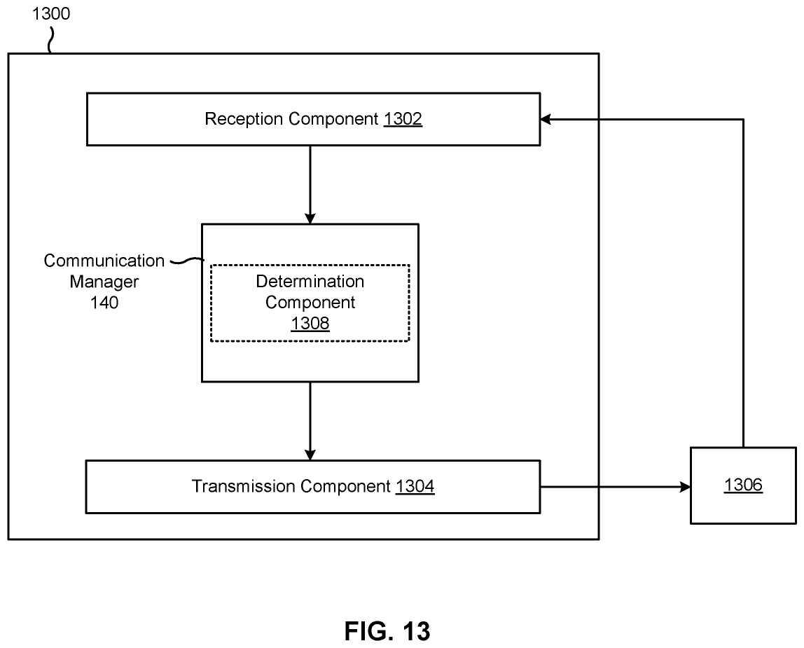

In some aspects, a UE (e.g., the UE 120 and/or apparatus 1300 of FIG. 13) may include means for determining a set of NZCs that are associated with CJT and multiple TRPs of a network and/or means for transmitting UCI indicating at least a portion of the set of NZCs ordered according to an order of the associated TRPs. Alternatively, the UE may include means for determining a set of NZCs that are associated with CJT and multiple TRPs of a network and/or means for transmitting UCI indicating at least a portion of the set of NZCs ordered according to an order of frequency bases for the set of NZCs. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

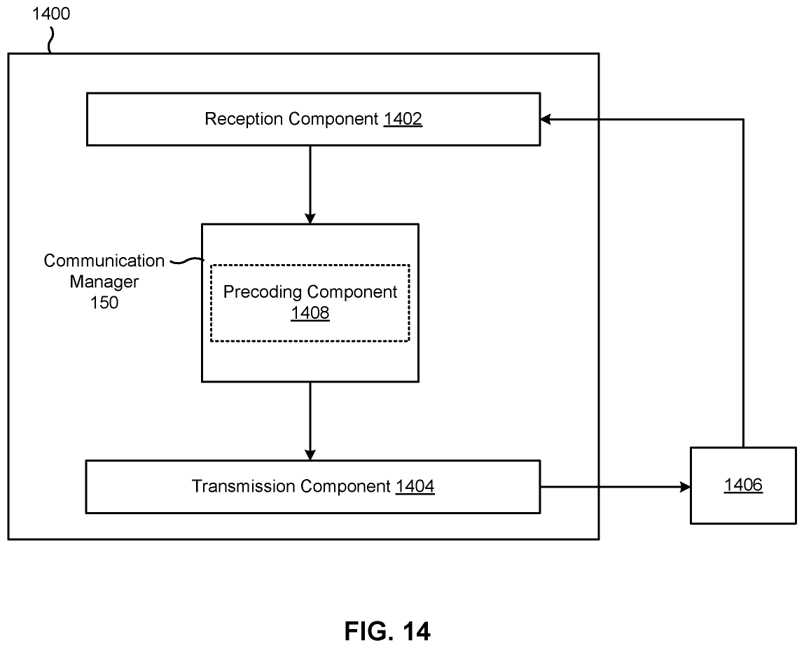

In some aspects, a network entity (e.g., the network node 110 and/or apparatus 1400 of FIG. 14) may include means for receiving UCI indicating at least a portion of a set of NZCs, associated with multiple TRPs, ordered according to an order of the associated TRPs and/or means for performing CJT precoding based on the portion of the set of NZCs. Alternatively, the network entity may include means for receiving UCI indicating at least a portion of a set of NZCs, associated with multiple TRPs, ordered according to an order of frequency bases for the set of NZCs and/or means for performing CJT precoding based on the portion of the set of NZCs. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

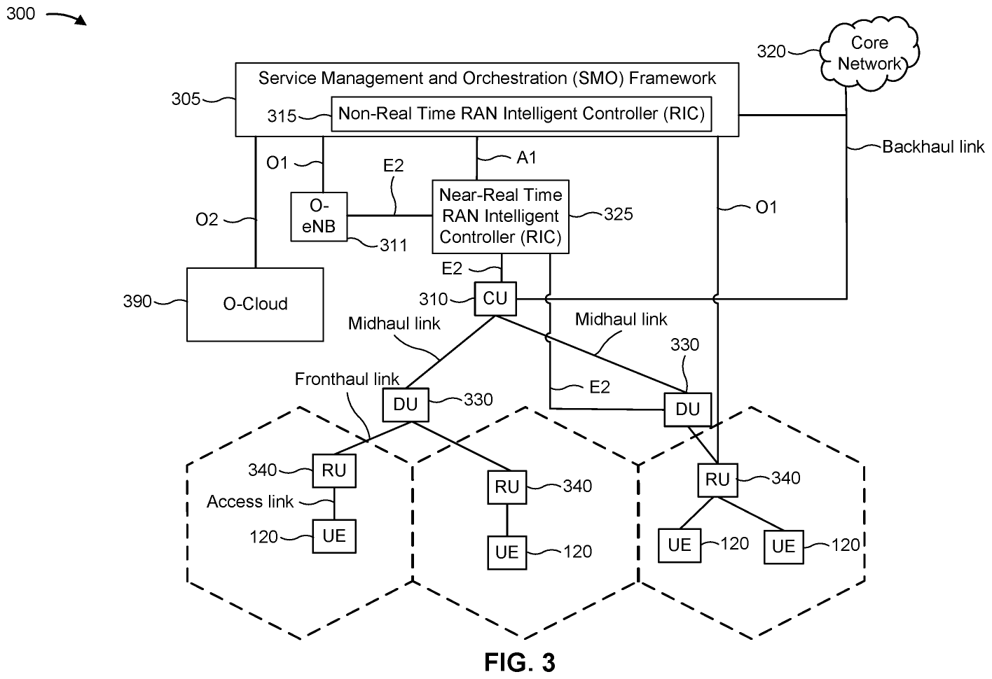

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

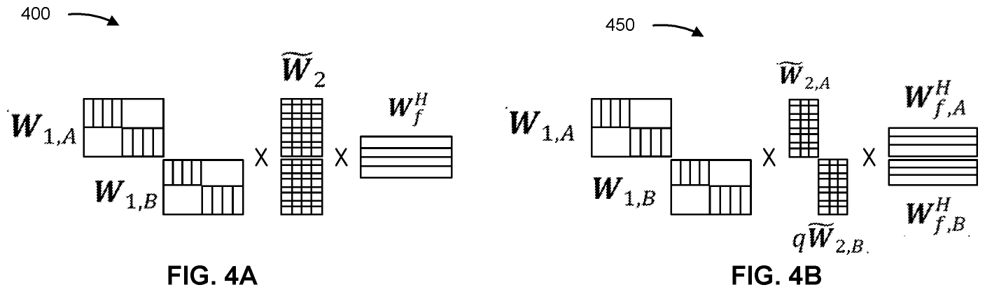

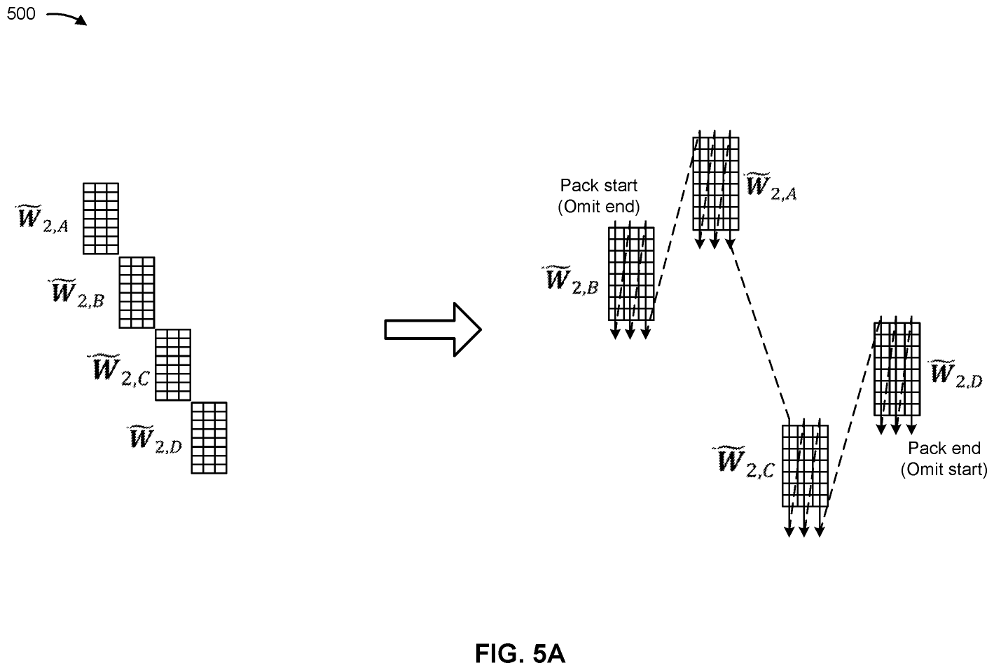

FIG. 4A is a diagram illustrating an example 400 of joint frequency domain CJT precoding, in accordance with the present disclosure. Example 400 uses a precoder associated with a TRPs of a network node 110 represented by W. The precoder may be composed from a spatial basis matrix for each TRP (e.g., represented by W_{1,A} and W_{1,B} in example 400, although other examples may use joint spatial bases represented by W₁), a frequency basis matrix (e.g., represented by W_{f}^{H} in example 400), and a coefficient matrix (e.g., represented by \tilde{W}₂ in example 400). The coefficient matrix is a normal matrix and thus represents a joint codebook for the TRPs. The TRPs perform CJT using one layer in example 400. Other examples may use additional layers (e.g., 2, 3, 4, and so on).

FIG. 4B is a diagram illustrating an example 450 of separate frequency domain CJT precoding, in accordance with the present disclosure. Example 450 uses a precoder associated with a TRPs of a network node 110 represented by W. The precoder may be composed from a spatial basis matrix for each TRP (e.g., represented by W_{1,A} and W_{1,B} in example 450, although other examples may use joint spatial bases represented by W₁), a frequency basis matrix for each TRP (e.g., represented by W_{f,A}^{H} and W_{f,B}^{H} in example 450), and a coefficient matrix (e.g., represented by a portion \tilde{W}_{2,A} associated with one TRP and a portion q\tilde{W}_{2,B} associated with another TRP in example 450). The coefficient matrix is a block-diagonal matrix and thus represents a semi-separate codebook for the TRPs. The TRPs perform CJT using one layer in example 450. Other examples may use additional layers (e.g., 2, 3, 4, and so on).

In order to select a coefficient matrix, an RU may transmit one or more reference signals to a UE so that the UE may report NZCs to use for the coefficient matrix. The UE generally transmits UCI to report the NZCs. For example, the UCI may include Part 1 UCI that includes a rank indicator (RI), a CQI value, and a number of NZCs (NNZC) and Part 2 UCI that indicates selected beams (e.g., for selecting spatial basis matrices), frequency domain bases, and NZC selections and quantized values for the coefficient matrix. Part 2 UCI may additionally include a strongest coefficient indication (SCI) for the coefficient matrix overall (also referred to as a “global SCI”) and/or an SCI for each portion of the coefficient matrix associated with a unique TRP (also referred to as “per-TRP SCI”).

When a physical uplink shared channel (PUSCH) resource is too small (e.g., in time and/or frequency) for the UE to transmit all NZCs, the UE orders the NZCs in order to decide which NZCs values to drop. When the RU is performing CJT, NZCs for some TRPs may be more important than NZCs for other TRPs (e.g., when one TRP is associated with a significantly higher gain than another TRP). Additionally, or alternatively, NZCs for some frequency bases may be more important than NZCs for other frequency bases (e.g., when TRPs are associated with different propagation delays such that different frequency bases are important for different TRPs).

Accordingly, some techniques and apparatuses described herein enable a UE (e.g., UE 120) to order NZCs according to an order of TRPs (optionally further according to an order of frequency bases) or according to an order of frequency bases (optionally further according to an order of TRPs). As a result, the UE 120 reports NZCs that are most likely to improve quality and reliability of CJT communications and drops NZCs that are less likely to do so. Accordingly, the UE 120 conserves power and processing resources during reporting as well as by decreasing chances of retransmissions from a network node (e.g., RU 340) to the UE 120.

As indicated above, FIGS. 4A and 4B are provided as examples. Other examples may differ from what is described with regard to FIGS. 4A and 4B.

FIG. 5A is a diagram illustrating an example 500 associated with NZC ordering for a semi-separate codebook, in accordance with the present disclosure. As shown in FIG. 5A, example 500 includes a coefficient matrix (e.g., represented by a portion \tilde{W}_{2,A} associated with a first TRP, a portion \tilde{W}_{2,B} associated with a second TRP, a portion \tilde{W}_{2,C} associated with a third TRP, and a portion \tilde{W}_{2,D} associated with a fourth TRP). Although described in connection with four TRPs, the description similarly applies to fewer TRPs (e.g., three TRPs or two TRPs) or additional TRPs (e.g., five TRPs, six TRPs, and so on).

A UE (e.g., UE 120) may determine a set of NZCs for the coefficient matrix based on measurements from multiple TRPs of a network (e.g., associated with one or more RUs 340) that are to perform CJT to the UE 120. Accordingly, the UE 120 orders the set of NZCs in order to determine which NZCs to include in UCI first (indicated as “Pack start” in example 500) and which NZCs to omit from UCI first (indicated as “Omit start” in example 500). Therefore, a size of the portion of the set of NZCs (that is, how many NZCs are transmitted in UCI) is based at least in part on a size of resources for a PUSCH associated with the UCI. For example, the UE 120 will omit more NZCs when the PUSCH is smaller (in time and/or frequency) but will encode more NZCs when the PUSCH is larger.

In example 500, the UCI indicates at least a portion of the set of NZCs ordered according to an order of the associated TRPs. In some aspects, the order of the associated TRPs may be a natural order of indices of the associated TRPs. For example, NZCs associated with a TRP having an index represented by i have a higher priority than NZCs associated with a TRP having an index represented by j when j>i. Accordingly, as used herein, “natural order” refers to a counting order of integers, that is, 0, 1, 2, and so on.

Alternatively, the UE 120 may encode a global SCI in the UCI, and the portion of the set of NZCs may begin with NZCs associated with the TRP that is associated with the global SCI. For example, the TRP associated with the global SCI may have an index represented by i₀. Therefore, the order of the associated TRPs may begin with TRP i₀ and continue with the TRP having index mod(i₀+1, N), the TRP having index mod(i₀+2, N), and continuing until the TRP having index mod(i₀+N−1, N), where N represents the quantity of TRPs being used. Accordingly, in one example, when 4 TRPs are being used a strongest coefficient is associated with TRP having index 1, the NZCs associated with the TRP having index 1 are ordered before the NZCs associated with the TRP having index 2, which are ordered before the NZCs associated with the TRP having index 3, and the NZCs associated with the TRP having index 0 are ordered last.

Alternatively, as shown in FIG. 5A, the UE 120 may order the TRPs and include, in the UCI, a bit sequence indicating the order of the associated TRPs. In example 500, the UE 120 indicates that the order of TRPs is according to the index sequence 1, 0, 3, 2. For example, the UE 120 may order the TRPs according to gain or according to per-TRP SCI, among other examples. The UE 120 may indicate each TRP index in the order such that the bit sequence includes ┌log₂(N!)┐ bits, where N represents the quantity of TRPs being used. Alternatively, the UE 120 may include a global SCI and omits the index of the TRP associated with the global SCI. Accordingly, the bit sequence may include ┌log₂((N−1)!)┐ bits.

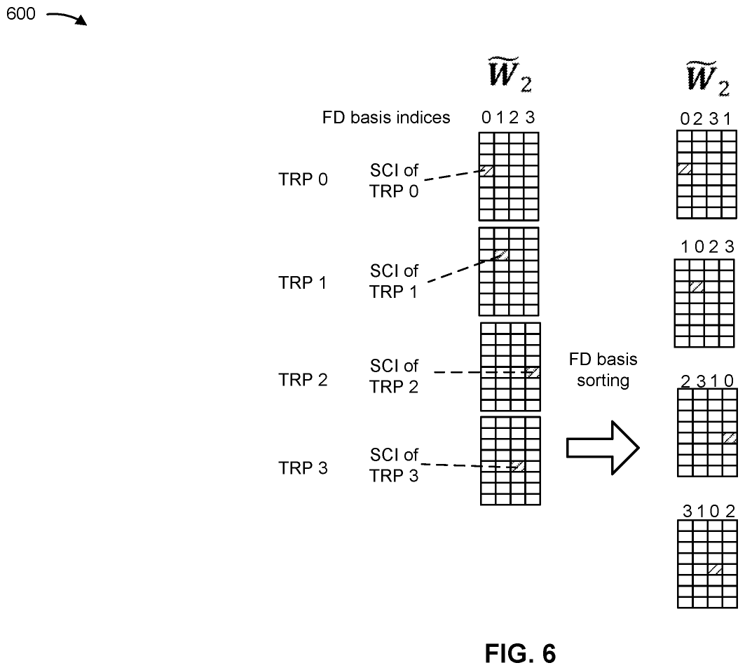

The portion of the set of NZCs included in the UCI is further ordered according to an order of frequency bases (shown as columns in FIG. 5A) for the set of NZCs. In some aspects, as shown in FIG. 5A, the NZCs are further ordered according to a natural order of the frequency bases (e.g., a leftmost column is included in UCI before a rightmost column). Alternatively, as described in connection with FIG. 6, the NZCs may be further ordered according to a permutation based at least in part on a strongest coefficient associated with the TRP. Finally, the portion of the set of NZCs included in the UCI are ordered according to an order of spatial bases (shown as rows in FIG. 5A) for the set of NZCs. In some aspects, as shown in FIG. 5A, the NZCs are further ordered according to a natural order of the spatial bases (e.g., a top row is included in UCI before a bottom row).

FIG. 5B is a diagram illustrating an example 550 associated with NZC ordering for a joint codebook, in accordance with the present disclosure. As shown in FIG. 5B, example 550 includes a coefficient matrix (e.g., represented by a portion \tilde{W}₂ with different portions associated with a first TRP, a second TRP, a third TRP, and a fourth TRP). Although described in connection with four TRPs, the description similarly applies to fewer TRPs (e.g., three TRPs or two TRPs) or additional TRPs (e.g., five TRPs, six TRPs, and so on).

As described above, the UE 120 may determine a set of NZCs for the coefficient matrix based on measurements from multiple TRPs of a network (e.g., associated with one or more RUs 340) that are to perform CJT to the UE 120. Accordingly, the UE 120 orders the set of NZCs in order to determine which NZCs to include in UCI first (indicated as “Pack start” in example 550) and which NZCs to omit from UCI first (indicated as “Omit start” in example 550). Therefore, a size of the portion of the set of NZCs (that is, how many NZCs are transmitted in UCI) is based at least in part on a size of resources for a PUSCH associated with the UCI. For example, the UE 120 will omit more NZCs when the PUSCH is smaller (in time and/or frequency) but will encode more NZCs when the PUSCH is larger.

In example 550, the UCI indicates at least a portion of the set of NZCs ordered according to an order of the associated TRPs. In some aspects, the order of the associated TRPs may be a natural order of indices of the associated TRPs.

Alternatively, the UE 120 may encode a global SCI in the UCI, and the portion of the set of NZCs may begin with NZCs associated with the TRP that is associated with the global SCI. For example, the TRP associated with the global SCI may have an index represented by i₀. Therefore, the order of the associated TRPs may begin with TRP i₀ and continue with the TRP having index mod(i₀+1, N), the TRP having index mod(i₀+2, N), and continuing until the TRP having index mod(i₀+N−1, N), where N represents the quantity of TRPs being used. Accordingly, in one example, when 4 TRPs are being used a strongest coefficient is associated with TRP having index 1, the NZCs associated with the TRP having index 1 are ordered before the NZCs associated with the TRP having index 2, which are ordered before the NZCs associated with the TRP having index 3, and the NZCs associated with the TRP having index 0 are ordered last.

Alternatively, as shown in FIG. 5B, the UE 120 may order the TRPs and include, in the UCI, a bit sequence indicating the order of the associated TRPs. In example 550, the UE 120 indicates that the order of TRPs is according to the index sequence 1, 0, 3, 2. For example, the UE 120 may order the TRPs according to gain or according to per-TRP SCI, among other examples. The UE 120 may indicate each TRP index in the order such that the bit sequence includes ┌log₂(N!)┐ bits, where N represents the quantity of TRPs being used. Alternatively, the UE 120 may include a global SCI and omits the index of the TRP associated with the global SCI. Accordingly, the bit sequence may include log₂((N−1)!)┐ bits.

The portion of the set of NZCs included in the UCI is further ordered according to an order of frequency bases (shown as columns in FIG. 5B) for the set of NZCs. In some aspects, as shown in FIG. 5B, the NZCs are further ordered according to a natural order of the frequency bases (e.g., a leftmost column is included in UCI before a rightmost column). Alternatively, as described in connection with FIG. 6, the NZCs may be further ordered according to a permutation based at least in part on a strongest coefficient associated with the TRP. Finally, the portion of the set of NZCs included in the UCI are ordered according to an order of spatial bases (shown as rows in FIG. 5B) for the set of NZCs. In some aspects, as shown in FIG. 5B, the NZCs are further ordered according to a natural order of the spatial bases (e.g., a top row is included in UCI before a bottom row).

By using techniques as described in connection with FIGS. 5A and 5B, the UE 120 order NZCs according to an order of TRPs (and further according to an order of frequency bases). As a result, the UE 120 reports NZCs that are most likely to improve quality and reliability of CJT communications and drops NZCs that are less likely to do so. Accordingly, the UE 120 conserves power and processing resources during reporting as well as by decreasing chances of retransmissions from the one or more RUs 340 to the UE 120.

As indicated above, FIGS. 5A and 5B are provided as examples. Other examples may differ from what is described with regard to FIGS. 5A and 5B.

FIG. 6 is a diagram illustrating an example 600 associated with permutating frequency domain bases, in accordance with the present disclosure. As shown in FIG. 6, example 600 includes a coefficient matrix (e.g., represented by a portion \tilde{W}₂ with different portions associated with a first TRP, a second TRP, a third TRP, and a fourth TRP). The coefficient matrix in example 600 is similar to the coefficient matrix in example 550 of FIG. 5B. Although described for a joint codebook, the description similarly applies to a semi-separate codebook (e.g., as shown in FIG. 5A), where the coefficient matrix is a block-diagonal matrix that includes portions portion \tilde{W}_{2,A} associated with a first TRP, \tilde{W}_{2,B} associated with a second TRP, \tilde{W}_{2,C} associated with a third TRP, and \tilde{W}_{2,D} associated with a fourth TRP. Although described in connection with four TRPs, the description similarly applies to fewer TRPs (e.g., three TRPs or two TRPs) or additional TRPs (e.g., five TRPs, six TRPs, and so on).

As shown in FIG. 6, the UE 120 may identify per-TRP SCIs. Accordingly, the UE 120 may re-order the frequency bases for each TRP such that the column with the strongest coefficient is re-indexed to be first (shown as 1 in example 600 but may be 0 in other examples). Remaining frequency bases may be re-indexed based on distance to the column with the strongest coefficient (e.g., the two closest columns are re-indexed as second and third, as shown in FIG. 6, the two next-closest columns are re-indexed as fourth and fifth, and so on).

By using techniques as described in connection with FIG. 6, the UE 120 order NZCs according to an order of TRPs and further according to which frequency bases are associated with strongest coefficients. As a result, the UE 120 reports NZCs that are most likely to improve quality and reliability of CJT communications and drops NZCs that are less likely to do so. Accordingly, the UE 120 conserves power and processing resources during reporting as well as by decreasing chances of retransmissions from the one or more RUs 340 to the UE 120.

As indicated above, FIG. 6 is provided as an example. Other examples may differ from what is described with respect to FIG. 6.

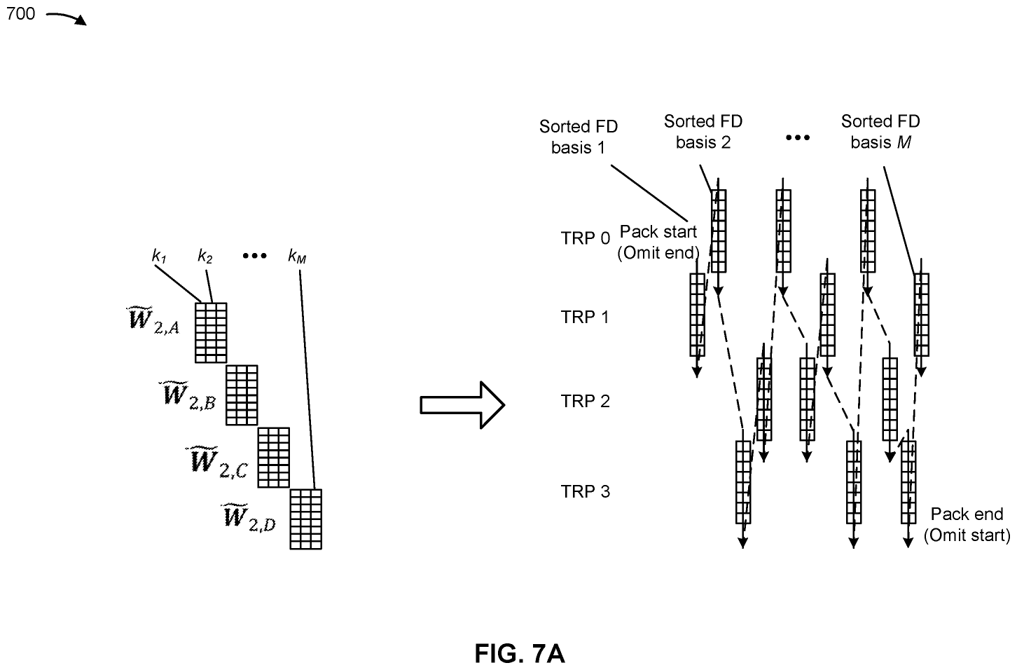

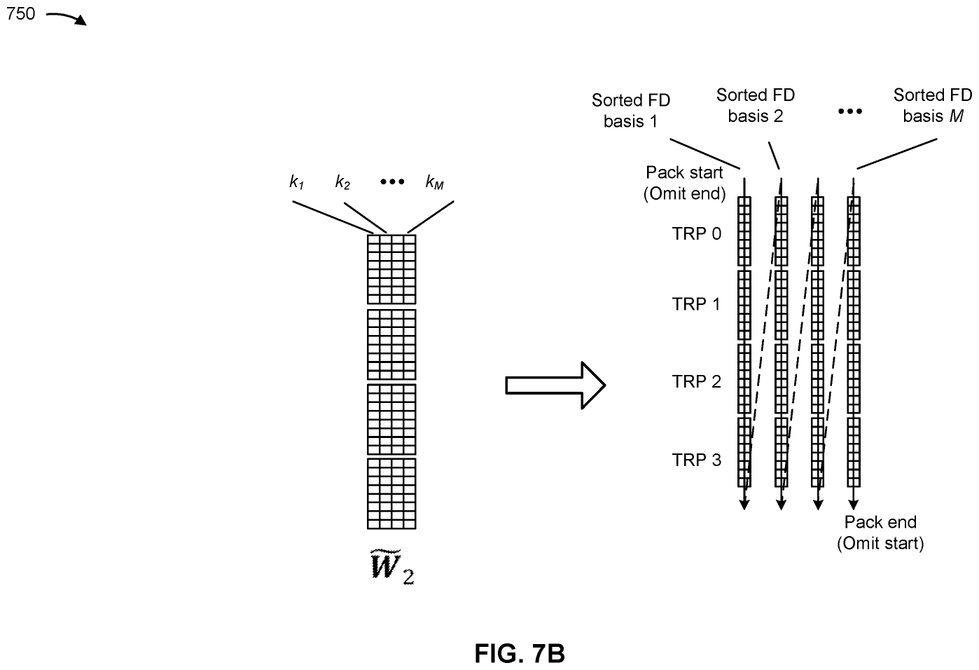

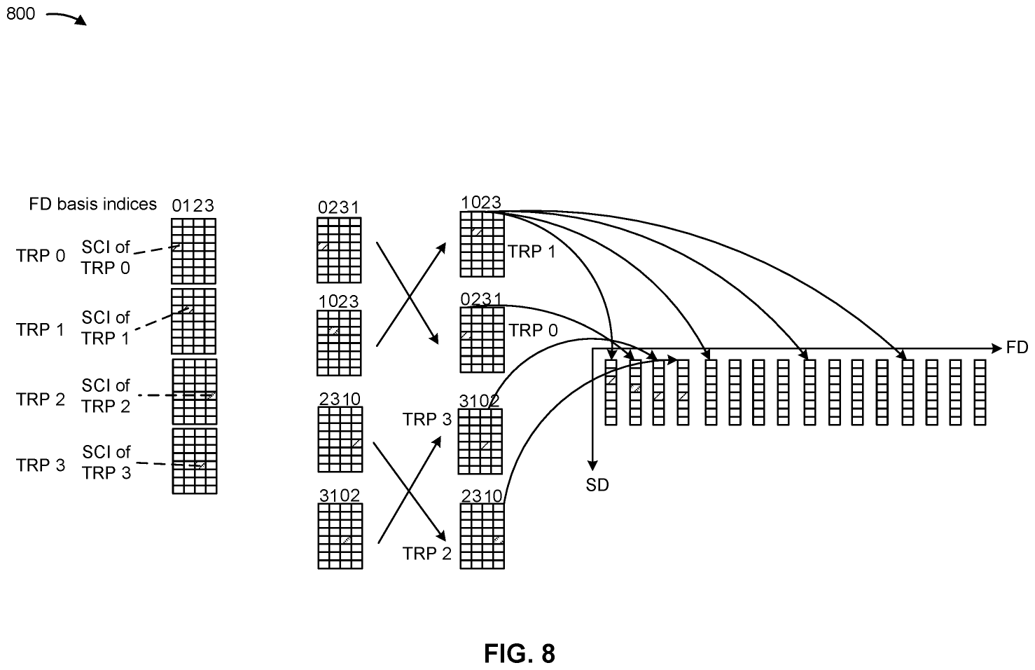

FIG. 7A is a diagram illustrating an example 700 associated with NZC ordering for a semi-separate codebook, in accordance with the present disclosure. As shown in FIG. 5A, example 700 includes a coefficient matrix (e.g., represented by a portion \tilde{W}_{2,A} associated with a first TRP, a portion \tilde{W}_{2,B} associated with a second TRP, a portion \tilde{W}_{2,C} associated with a third TRP, a portion \tilde{W}_{2,D} associated with a fourth TRP). Although described in connection with four TRPs, the description similarly applies to fewer TRPs (e.g., three TRPs or two TRPs) or additional TRPs (e.g., five TRPs, six TRPs, and so on).

A UE (e.g., UE 120) may determine a set of NZCs for the coefficient matrix based on measurements from multiple TRPs of a network (e.g., associated with one or more RUs 340) that are to perform CJT to the UE 120. Accordingly, the UE 120 orders the set of NZCs in order to determine which NZCs to include in UCI first (indicated as “Pack start” in example 700) and which NZCs to omit from UCI first (indicated as “Omit start” in example 700). Therefore, a size of the portion of the set of NZCs (that is, how many NZCs are transmitted in UCI) is based at least in part on a size of resources for a PUSCH associated with the UCI. For example, the UE 120 will omit more NZCs when the PUSCH is smaller (in time and/or frequency) but will encode more NZCs when the PUSCH is larger.

In example 700, the UCI indicates at least a portion of the set of NZCs ordered according to an order of indices of the frequency bases. In some aspects, the order of the frequency bases may be a natural order of the indices. For example, NZCs associated with a frequency basis having an index represented by i have a higher priority than NZCs associated with a TRP having an index represented by j when j>i.

Alternatively, the portion of the set of NZCs may be ordered according to a permutation of indices of the frequency bases. For example, the order of the frequency bases may begin with frequency basis having index 0 and continue according to M−1, 1, M−2, . . . , └M/2┘ where M represents the quantity of frequency bases. Accordingly, in one example, when 4 frequency bases are being used, NZCs associated with the frequency basis having index 0 are ordered before NZCs associated with the frequency basis having index 3, which are ordered before the NZCs associated with the frequency basis having index 1, and the NZCs associated with the frequency basis having index 2 are ordered last.

Alternatively, as shown in FIG. 7A, the UE 120 may order the frequency bases and include, in the UCI, a bit sequence indicating the order of the associated frequency bases. For example, the UE 120 may order the frequency bases according to coefficient size or according to per-TRP SCI, among other examples. The UE 120 may indicate each frequency basis index in the order such that the bit sequence has a length of Σᵢ₌₁^{N}Mᵢ, where Mᵢ represents a quantity of columns for the portion of the coefficient matrix associated with the TRP having index i, and N represents the quantity of TRPs being used. Accordingly, the bit sequences includes ┌log₂(M!)┐ bits. Alternatively, the UE 120 may include a global SCI and omits the index of the frequency basis associated with the global SCI. Accordingly, the bit sequence may include ┌log₂((M−1)!)┐ bits.

The portion of the set of NZCs included in the UCI is further ordered according to an order of spatial bases (shown as rows in FIG. 7A) for the set of NZCs. In some aspects, as shown in FIG. 7A, the NZCs are further ordered according to a natural order of the spatial bases (e.g., a top row is included in UCI before a bottom row).

FIG. 7B is a diagram illustrating an example 750 associated with NZC ordering for a joint codebook, in accordance with the present disclosure. As shown in FIG. 7B, example 750 includes a coefficient matrix (e.g., represented by a portion \tilde{W}₂ with different portions associated with a first TRP, a second TRP, a third TRP, and a fourth TRP). Although described in connection with four TRPs, the description similarly applies to fewer TRPs (e.g., three TRPs or two TRPs) or additional TRPs (e.g., five TRPs, six TRPs, and so on).

As described above, the UE 120 may determine a set of NZCs for the coefficient matrix based on measurements from multiple TRPs of a network (e.g., associated with one or more RUs 340) that are to perform CJT to the UE 120. Accordingly, the UE 120 orders the set of NZCs in order to determine which NZCs to include in UCI first (indicated as “Pack start” in example 750) and which NZCs to omit from UCI first (indicated as “Omit start” in example 750). Therefore, a size of the portion of the set of NZCs (that is, how many NZCs are transmitted in UCI) is based at least in part on a size of resources for a PUSCH associated with the UCI. For example, the UE 120 will omit more NZCs when the PUSCH is smaller (in time and/or frequency) but will encode more NZCs when the PUSCH is larger.

In example 750, the UCI indicates at least a portion of the set of NZCs ordered according to an order of indices of frequency bases. In some aspects, the order of the frequency bases may be a natural order of the indices of the frequency bases.

Alternatively, the portion of the set of NZCs may be ordered according to a permutation of indices of the frequency bases. For example, the order of the frequency bases may begin with frequency basis having index 0 and continue according to M−1, 1, M−2, . . . , └M/2┘ where M represents the quantity of frequency bases. Accordingly, in one example, when 4 frequency bases are being used, NZCs associated with the frequency basis having index 0 are ordered before NZCs associated with the frequency basis having index 3, which are ordered before the NZCs associated with the frequency basis having index 1, and the NZCs associated with the frequency basis having index 2 are ordered last.

Alternatively, as shown in FIG. 7B, the UE 120 may order the TRPs and include, in the UCI, a bit sequence indicating the order of the associated TRPs. For example, the UE 120 may order the frequency bases according to coefficient size or according to per-TRP SCI, among other examples. The UE 120 may indicate each frequency basis index in the order such that the bit sequences includes ┌log₂(M!)┐ bits, where M represents a quantity of columns for the coefficient matrix. Alternatively, the UE 120 may include a global SCI and omits the index of the frequency basis associated with the global SCI. Accordingly, the bit sequence may include ┌log₂((M−1)!)┐ bits.

The portion of the set of NZCs included in the UCI is further ordered according to an order of TRPs (shown as different portions of each column in FIG. 7B) for the set of NZCs. In some aspects, as shown in FIG. 7B, the TRPs are ordered according to a natural order of indices associated with the TRPs (e.g., a top row is included in UCI before a bottom row).

Finally, the portion of the set of NZCs included in the UCI are ordered according to an order of spatial bases (shown as rows in FIG. 7B) for the set of NZCs. In some aspects, as shown in FIG. 7B, the NZCs are further ordered according to a natural order of the spatial bases (e.g., a top row is included in UCI before a bottom row).

By using techniques as described in connection with FIGS. 7A and 7B, the UE 120 order NZCs according to an order of frequency bases. As a result, the UE 120 reports NZCs that are most likely to improve quality and reliability of CJT communications and drops NZCs that are less likely to do so. Accordingly, the UE 120 conserves power and processing resources during reporting as well as by decreasing chances of retransmissions from the one or more RUs 340 to the UE 120.

As indicated above, FIGS. 7A and 7B are provided as examples. Other examples may differ from what is described with regard to FIGS. 7A and 7B.

FIG. 8 is a diagram illustrating an example 800 associated with NZC ordering for a joint codebook, in accordance with the present disclosure. As shown in FIG. 8, example 800 includes a coefficient matrix (e.g., represented by a portion \tilde{W}₂ with different portions associated with a first TRP, a second TRP, a third TRP, and a fourth TRP). The coefficient matrix in example 800 is similar to the coefficient matrix in example 750 of FIG. 7B. Although described for a joint codebook, the description similarly applies to a semi-separate codebook (e.g., as shown in FIG. 7A), where the coefficient matrix is a block-diagonal matrix that includes portions portion \tilde{W}_{2,A} associated with a first TRP, \tilde{W}_{2,B} associated with a second TRP, \tilde{W}_{2,C} associated with a third TRP, and \tilde{W}_{2,D} associated with a fourth TRP. Although described in connection with four TRPs, the description similarly applies to fewer TRPs (e.g., three TRPs or two TRPs) or additional TRPs (e.g., five TRPs, six TRPs, and so on).

Similar to FIG. 6, the UE 120 may identify per-TRP SCIs. Accordingly, the UE 120 may re-order the frequency bases for each TRP such that the column with the strongest coefficient is re-indexed to be first (shown as 1 in example 600 but may be 0 in other examples). Remaining frequency bases may be re-indexed based on distance to the column with the strongest coefficient (e.g., the two closest columns are re-indexed as second and third, as shown in FIG. 6, the two next-closest columns are re-indexed as fourth and fifth, and so on). Alternatively, the UE 120 may sort the frequency bases according to other measures (e.g., according to coefficient size or according to per-TRP SCI, as described in connection with FIGS. 7A and 7B). By sorting the frequency bases, the UE 120 does not include, in the UCI, a bit sequence indicating the order of frequency bases, which reduces a size of the UCI.

The UE 120 subsequently groups the set of sorted frequency bases into subsets. Accordingly, the portion of the set of NZCs includes a plurality of subsets, wherein each subset includes at least one frequency basis. For example, the UE 120 may segment the set of sorted frequency bases into S subsets, where each subset includes M_{S} frequency bases, such that Σₛ₌₁^{S}Mₛ=M, where M represents the quantity of frequency domain bases. In example 600, S=M such that Mₛ≡1 (thus each subset has only one frequency basis). In other examples, each subset may include a plurality of frequency bases. For example, the quantity of frequency domain bases in each subset may be indicated by the network (e.g., via one or more RUs 340).

The portion of the set of NZCs included in the UCI is further ordered according to an order of TRPs (shown as different portions of each column in FIG. 8) for the set of NZCs. In some aspects, the TRPs are ordered according to a natural order of indices associated with the TRPs (e.g., a top row is included in UCI before a bottom row). Alternatively, as shown in FIG. 8, the UE 120 may order the TRPs and include, in the UCI, a bit sequence indicating the order of the associated TRPs. In example 800, the UE 120 indicates that the order of TRPs is according to the index sequence 1, 0, 3, 2. For example, the UE 120 may order the TRPs according to gain or according to per-TRP SCI, among other examples. The UE 120 may indicate each TRP index in the order such that the bit sequence includes ┌log₂(N!)┐ bits, where N represents the quantity of TRPs being used. Alternatively, the UE 120 may include a global SCI and omits the index of the TRP associated with the global SCI. Accordingly, the bit sequence may include ┌log₂((N−1)!)┐ bits.

The UE 120 encodes frequency bases included in each subset according to the order of TRPs. Thus, in example 800, the subset including the top-sorted frequency bases for TRP with index 1 is ordered before the subset including the top-sorted frequency bases for TRP with index 0, which is ordered before the subset including the top-sorted frequency bases for TRP with index 3, and the subset including the top-sorted frequency bases for TRP with index 2 is ordered last. The subsets with the next-top-sorted frequency bases are ordered similarly by TRP until the subset including the bottom-sorted frequency bases is ordered last by TRP.

Finally, the portion of the set of NZCs included in the UCI are ordered according to an order of spatial bases (shown as rows in FIG. 8) for the set of NZCs. In some aspects, as shown in FIG. 8, the NZCs are further ordered according to a natural order of the spatial bases (e.g., a top row is included in UCI before a bottom row).

By using techniques as described in connection with FIG. 8, the UE 120 order NZCs according to an order of frequency bases and further according to which TRPs are associated with strongest gain. As a result, the UE 120 reports NZCs that are most likely to improve quality and reliability of CJT communications and drops NZCs that are less likely to do so. Accordingly, the UE 120 conserves power and processing resources during reporting as well as by decreasing chances of retransmissions from the one or more RUs 340 to the UE 120.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120 and/or apparatus 1300 of FIG. 13) performs operations associated with ordering NZCs for CJT precoding.

As shown in FIG. 9, in some aspects, process 900 may include determining a set of NZCs that are associated with CJT and multiple TRPs of a network (block 910). For example, the UE (e.g., using communication manager 140 and/or determination component 1308, depicted in FIG. 13) may determine a set of NZCs that are associated with CJT and multiple TRPs of a network, as described herein.

As further shown in FIG. 9, in some aspects, process 900 may include transmitting UCI indicating at least a portion of the set of NZCs ordered according to an order of the associated TRPs (block 920). For example, the UE (e.g., using communication manager 140 and/or transmission component 1304, depicted in FIG. 13) may transmit UCI indicating at least a portion of the set of NZCs ordered according to an order of the associated TRPs, as described herein.

Process 900 may include additional aspects, such as any single aspect or any combination of aspects described below and/or in connection with one or more other processes described elsewhere herein.

In a first aspect, a size of the portion of the set of NZCs is based at least in part on a size of resources for a PUSCH associated with the UCI.

In a second aspect, alone or in combination with the first aspect, the portion of the set of NZCs is ordered according to a natural order of indices of the associated TRPs.

In a third aspect, alone or in combination with one or more of the first and second aspects, the UCI includes a strongest coefficient indication, and the portion of the set of NZCs begins with NZCs associated with a TRP, of the TRPs, associated with the strongest coefficient indication.

In a fourth aspect, alone or in combination with one or more of the first through third aspects, the UCI includes a bit sequence indicating the order of the associated TRPs.

In a fifth aspect, alone or in combination with one or more of the first through fourth aspects, the UCI further includes a strongest coefficient indication, and the bit sequence omits a TRP, of the TRPs, associated with the strongest coefficient indication.

In a sixth aspect, alone or in combination with one or more of the first through fifth aspects, the portion of the set of NZCs is further ordered according to an order of frequency bases for the set of NZCs.

In a seventh aspect, alone or in combination with one or more of the first through sixth aspects, the order of the frequency bases for each TRP is based at least in part on a strongest coefficient associated with the TRP.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network entity, in accordance with the present disclosure. Example process 1000 is an example where the network entity (e.g., network node 110 and/or apparatus 1400 of FIG. 14) performs operations associated with ordering NZCs for CJT precoding.

As shown in FIG. 10, in some aspects, process 1000 may include receiving UCI indicating at least a portion of a set of NZCs, associated with multiple TRPs, ordered according to an order of the associated TRPs (block 1010). For example, the network entity (e.g., using communication manager 150 and/or reception component 1402, depicted in FIG. 14) may receive UCI indicating at least a portion of a set of NZCs, associated with multiple TRPs, ordered according to an order of the associated TRPs, as described herein.

As further shown in FIG. 10, in some aspects, process 1000 may include performing CJT precoding based on the portion of the set of NZCs (block 1020). For example, the network entity (e.g., using communication manager 150 and/or precoding component 1408, depicted in FIG. 14) may perform CJT precoding based on the portion of the set of NZCs, as described herein.

Process 1000 may include additional aspects, such as any single aspect or any combination of aspects described below and/or in connection with one or more other processes described elsewhere herein.

In a first aspect, process 1000 includes transmitting (e.g., using communication manager 150 and/or transmission component 1404, depicted in FIG. 14) a grant for a PUSCH associated with the UCI, where a size of the portion of the set of NZCs is based at least in part on a size of resources associated with the grant.

In a second aspect, alone or in combination with the first aspect, the portion of the set of NZCs are ordered according to a natural order of indices of the associated TRPs.

In a third aspect, alone or in combination with one or more of the first and second aspects, the UCI includes a strongest coefficient indication, and the portion of the set of NZCs begins with NZCs associated with a TRP, of the TRPs, associated with the strongest coefficient indication.

In a fourth aspect, alone or in combination with one or more of the first through third aspects, the UCI includes a bit sequence indicating the order of the associated TRPs.

In a fifth aspect, alone or in combination with one or more of the first through fourth aspects, the UCI further includes a strongest coefficient indication, and the bit sequence omits a TRP, of the TRPs, associated with the strongest coefficient indication.

In a sixth aspect, alone or in combination with one or more of the first through fifth aspects, the portion of the set of NZCs is further ordered according to an order of frequency bases for the set of NZCs.

In a seventh aspect, alone or in combination with one or more of the first through sixth aspects, the order of the frequency bases for each TRP is based at least in part on a strongest coefficient associated with the TRP.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120 and/or apparatus 1300 of FIG. 13) performs operations associated with ordering NZCs for CJT precoding.

As shown in FIG. 11, in some aspects, process 1100 may include determining a set of NZCs that are associated with CJT and multiple TRPs of a network (block 1110). For example, the UE (e.g., using communication manager 140 and/or determination component 1308, depicted in FIG. 13) may determine a set of NZCs that are associated with CJT and multiple TRPs of a network, as described herein.

As further shown in FIG. 11, in some aspects, process 1100 may include transmitting UCI indicating at least a portion of the set of NZCs ordered according to an order of frequency bases for the set of NZCs (block 1120). For example, the UE (e.g., using communication manager 140 and/or transmission component 1304, depicted in FIG. 13) may transmit UCI indicating at least a portion of the set of NZCs ordered according to an order of frequency bases for the set of NZCs, as described herein.

Process 1100 may include additional aspects, such as any single aspect or any combination of aspects described below and/or in connection with one or more other processes described elsewhere herein.

In a first aspect, a size of the portion of the set of NZCs is based at least in part on a size of resources for a PUSCH associated with the UCI.

In a second aspect, alone or in combination with the first aspect, the portion of the set of NZCs is ordered according to a natural order of indices of the frequency bases.

In a third aspect, alone or in combination with one or more of the first and second aspects, the portion of the set of NZCs is ordered according to a permutation of indices of the frequency bases.

In a fourth aspect, alone or in combination with one or more of the first through third aspects, the UCI includes a bit sequence indicating the order of the frequency bases.

In a fifth aspect, alone or in combination with one or more of the first through fourth aspects, the UCI further includes a strongest coefficient indication, and the bit sequence omits a frequency basis, of the frequency bases, associated with the strongest coefficient indication.

In a sixth aspect, alone or in combination with one or more of the first through fifth aspects, the portion of the set of NZCs is further ordered according to an order of the associated TRPs.

In a seventh aspect, alone or in combination with one or more of the first through sixth aspects, the portion of the set of NZCs includes a plurality of subsets, wherein each subset includes a plurality of the frequency bases.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network entity, in accordance with the present disclosure. Example process 1200 is an example where the network entity (e.g., network node 110 and/or apparatus 1400 of FIG. 14) performs operations associated with ordering NZCs for CJT precoding.

As shown in FIG. 12, in some aspects, process 1200 may include receiving UCI indicating at least a portion of a set of NZCs, associated with multiple TRPs, ordered according to an order of frequency bases for the set of NZCs (block 1210). For example, the network entity (e.g., using communication manager 150 and/or reception component 1402, depicted in FIG. 14) may receive UCI indicating at least a portion of a set of NZCs, associated with multiple TRPs, ordered according to an order of frequency bases for the set of NZCs, as described herein.

As further shown in FIG. 12, in some aspects, process 1200 may include performing CJT precoding based on the portion of the set of NZCs (block 1220). For example, the network entity (e.g., using communication manager 150 and/or precoding component 1408, depicted in FIG. 14) may perform CJT precoding based on the portion of the set of NZCs, as described herein.

Process 1200 may include additional aspects, such as any single aspect or any combination of aspects described below and/or in connection with one or more other processes described elsewhere herein.

In a first aspect, process 1200 includes transmitting (e.g., using communication manager 150 and/or transmission component 1404, depicted in FIG. 14) a grant for a PUSCH associated with the UCI, where a size of the portion of the set of NZCs is based at least in part on a size of resources associated with the grant.

In a second aspect, alone or in combination with the first aspect, the portion of the set of NZCs is ordered according to a natural order of indices of the frequency bases.

In a third aspect, alone or in combination with one or more of the first and second aspects, the portion of the set of NZCs is ordered according to a permutation of indices of the frequency bases.

In a fourth aspect, alone or in combination with one or more of the first through third aspects, the UCI includes a bit sequence indicating the order of the frequency bases.

In a fifth aspect, alone or in combination with one or more of the first through fourth aspects, the UCI further includes a strongest coefficient indication, and the bit sequence omits a frequency basis, of the frequency bases, associated with the strongest coefficient indication.

In a sixth aspect, alone or in combination with one or more of the first through fifth aspects, the portion of the set of NZCs is further ordered according to an order of the associated TRPs.

In a seventh aspect, alone or in combination with one or more of the first through sixth aspects, the portion of the set of NZCs includes a plurality of subsets, wherein each subset includes a plurality of the frequency bases.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, an RU, or another wireless communication device) using the reception component 1302 and the transmission component 1304. As further shown, the apparatus 1300 may include the communication manager 140. The communication manager 140 may include a determination component 1308, among other examples.

In some aspects, the apparatus 1300 may be configured to perform one or more operations described herein in connection with FIGS. 5A, 5B, 6, 7A, 7B, and 8. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

In some aspects, the determination component 1308 may determine a set of NZCs that are associated with CJT and multiple TRPs of a network. The determination component 1308 may include one or more antennas, a modem, a demodulator, a MIMO detector, a receive processor, a controller/processor, a memory, or a combination thereof, of the UE described in connection with FIG. 2. The transmission component 1304 may transmit (e.g., to the apparatus 1306) UCI indicating at least a portion of the set of NZCs ordered according to an order of the associated TRPs. Alternatively, the transmission component 1304 may transmit (e.g., to the apparatus 1306) UCI indicating at least a portion of the set of NZCs ordered according to an order of frequency bases for the set of NZCs.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network entity, or a network entity may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, an RU, or another wireless communication device) using the reception component 1402 and the transmission component 1404. As further shown, the apparatus 1400 may include the communication manager 150. The communication manager 150 may include a precoding component 1408, among other examples.

In some aspects, the apparatus 1400 may be configured to perform one or more operations described herein in connection with FIGS. 5A, 5B, 6, 7A, 7B, and 8. Additionally, or alternatively, the apparatus 1400 may be configured to perform one or more processes described herein, such as process 1000 of FIG. 10, process 1200 of FIG. 12, or a combination thereof. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network node described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the network node described in connection with FIG. 2. In some aspects, the transmission component 1404 may be co-located with the reception component 1402 in a transceiver.

In some aspects, the reception component 1402 may receive (e.g., from the apparatus 1406) UCI indicating at least a portion of a set of NZCs, associated with multiple TRPs, ordered according to an order of the associated TRPs. Alternatively, the reception component 1402 may receive (e.g., from the apparatus 1406) UCI indicating at least a portion of a set of NZCs, associated with multiple TRPs, ordered according to an order of frequency bases for the set of NZCs. The precoding component 1408 may perform CJT precoding based on the portion of the set of NZCs. The precoding component 1408 may include a transmit MIMO processor, a transmit processor, a controller/processor, a memory, or a combination thereof, of the network node described in connection with FIG. 2.

In some aspects, the transmission component 1404 may transmit (e.g., to the apparatus 1406) a grant for a PUSCH associated with the UCI. Accordingly, a size of the portion of the set of NZCs is based at least in part on a size of resources associated with the grant.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: determining a set of non-zero coefficients (NZCs) that are associated with coherent joint transmission (CJT) and multiple transmit-receive points (TRPs) of a network; and transmitting uplink control information (UCI) indicating at least a portion of the set of NZCs ordered according to an order of the associated TRPs.

Aspect 2: The method of Aspect 1, wherein a size of the portion of the set of NZCs is based at least in part on a size of resources for a physical uplink shared channel associated with the UCI.

Aspect 3: The method of any of Aspects 1 through 2, wherein the portion of the set of NZCs is ordered according to a natural order of indices of the associated TRPs.

Aspect 4: The method of any of Aspects 1 through 3, wherein the UCI includes a strongest coefficient indication, and the portion of the set of NZCs begins with NZCs associated with a TRP, of the TRPs, associated with the strongest coefficient indication.

Aspect 5: The method of any of Aspects 1 through 2, wherein the UCI includes a bit sequence indicating the order of the associated TRPs.

Aspect 6: The method of Aspect 5, wherein the UCI further includes a strongest coefficient indication, and the bit sequence omits a TRP, of the TRPs, associated with the strongest coefficient indication.

Aspect 7: The method of any of Aspects 1 through 6, wherein the portion of the set of NZCs is further ordered according to an order of frequency bases for the set of NZCs.

Aspect 8: The method of Aspect 7, wherein the order of the frequency bases for each TRP is based at least in part on a strongest coefficient associated with the TRP.

Aspect 9: A method of wireless communication performed by a network entity, comprising: receiving uplink control information (UCI) indicating at least a portion of a set of non-zero coefficients (NZCs), associated with multiple transmit-receive points (TRPs), ordered according to an order of the associated TRPs; and performing coherent joint transmission (CJT) precoding based on the portion of the set of NZCs.

Aspect 10: The method of Aspect 9, further comprising: transmitting a grant for a physical uplink shared channel associated with the UCI, wherein a size of the portion of the set of NZCs is based at least in part on a size of resources associated with the grant.

Aspect 11: The method of any of Aspects 9 through 10, wherein the portion of the set of NZCs are ordered according to a natural order of indices of the associated TRPs.

Aspect 12: The method of any of Aspects 9 through 11, wherein the UCI includes a strongest coefficient indication, and the portion of the set of NZCs begins with NZCs associated with a TRP, of the TRPs, associated with the strongest coefficient indication.

Aspect 13: The method of any of Aspects 9 through 10, wherein the UCI includes a bit sequence indicating the order of the associated TRPs.

Aspect 14: The method of Aspect 13, wherein the UCI further includes a strongest coefficient indication, and the bit sequence omits a TRP, of the TRPs, associated with the strongest coefficient indication.

Aspect 15: The method of any of Aspects 9 through 14, wherein the portion of the set of NZCs is further ordered according to an order of frequency bases for the set of NZCs.

Aspect 16: The method of Aspect 15, wherein the order of the frequency bases for each TRP is based at least in part on a strongest coefficient associated with the TRP.

Aspect 17: A method of wireless communication performed by a user equipment (UE), comprising: determining a set of non-zero coefficients (NZCs) that are associated with coherent joint transmission (CJT) and multiple transmit-receive points (TRPs) of a network; and transmitting uplink control information (UCI) indicating at least a portion of the set of NZCs ordered according to an order of frequency bases for the set of NZCs.

Aspect 18: The method of Aspect 17, wherein a size of the portion of the set of NZCs is based at least in part on a size of resources for a physical uplink shared channel associated with the UCI.

Aspect 19: The method of any of Aspects 17 through 18, wherein the portion of the set of NZCs is ordered according to a natural order of indices of the frequency bases.

Aspect 20: The method of any of Aspects 17 through 18, wherein the portion of the set of NZCs is ordered according to a permutation of indices of the frequency bases.

Aspect 21: The method of any of Aspects 17 through 18, wherein the UCI includes a bit sequence indicating the order of the frequency bases.

Aspect 22: The method of Aspect 21, wherein the UCI further includes a strongest coefficient indication, and the bit sequence omits a frequency basis, of the frequency bases, associated with the strongest coefficient indication.

Aspect 23: The method of any of Aspects 17 through 22, wherein the portion of the set of NZCs is further ordered according to an order of the associated TRPs.

Aspect 24: The method of any of Aspects 17 through 18, wherein the portion of the set of NZCs includes a plurality of subsets, wherein each subset includes a plurality of the frequency bases.

Aspect 25: A method of wireless communication performed by a network entity, comprising: receiving uplink control information (UCI) indicating at least a portion of a set of non-zero coefficients (NZCs), associated with multiple transmit-receive points (TRPs), ordered according to an order of frequency bases for the set of NZCs; and performing coherent joint transmission (CJT) precoding based on the portion of the set of NZCs.

Aspect 26: The method of Aspect 25, further comprising: transmitting a grant for a physical uplink shared channel associated with the UCI, wherein a size of the portion of the set of NZCs is based at least in part on a size of resources associated with the grant.

Aspect 27: The method of any of Aspects 25 through 26, wherein the portion of the set of NZCs is ordered according to a natural order of indices of the frequency bases.

Aspect 28: The method of any of Aspects 25 through 26, wherein the portion of the set of NZCs is ordered according to a permutation of indices of the frequency bases.

Aspect 29: The method of any of Aspects 25 through 26, wherein the UCI includes a bit sequence indicating the order of the frequency bases.

Aspect 30: The method of Aspect 29, wherein the UCI further includes a strongest coefficient indication, and the bit sequence omits a frequency basis, of the frequency bases, associated with the strongest coefficient indication.

Aspect 31: The method of any of Aspects 25 through 30, wherein the portion of the set of NZCs is further ordered according to an order of the associated TRPs.

Aspect 32: The method of any of Aspects 25 through 26, wherein the portion of the set of NZCs includes a plurality of subsets, wherein each subset includes a plurality of the frequency bases.

Aspect 33: An apparatus for wireless communication at a device, comprising a processor; memory coupled with the processor; and instructions stored in the memory and executable by the processor to cause the apparatus to perform the method of one or more of Aspects 1-8.

Aspect 34: A device for wireless communication, comprising a memory and one or more processors coupled to the memory, the one or more processors configured to perform the method of one or more of Aspects 1-8.

Aspect 35: An apparatus for wireless communication, comprising at least one means for performing the method of one or more of Aspects 1-8.

Aspect 36: A non-transitory computer-readable medium storing code for wireless communication, the code comprising instructions executable by a processor to perform the method of one or more of Aspects 1-8.

Aspect 37: A non-transitory computer-readable medium storing a set of instructions for wireless communication, the set of instructions comprising one or more instructions that, when executed by one or more processors of a device, cause the device to perform the method of one or more of Aspects 1-8.

Aspect 38: An apparatus for wireless communication at a device, comprising a processor; memory coupled with the processor; and instructions stored in the memory and executable by the processor to cause the apparatus to perform the method of one or more of Aspects 9-16.

Aspect 39: A device for wireless communication, comprising a memory and one or more processors coupled to the memory, the one or more processors configured to perform the method of one or more of Aspects 9-16.

Aspect 40: An apparatus for wireless communication, comprising at least one means for performing the method of one or more of Aspects 9-16.

Aspect 41: A non-transitory computer-readable medium storing code for wireless communication, the code comprising instructions executable by a processor to perform the method of one or more of Aspects 9-16.

Aspect 42: A non-transitory computer-readable medium storing a set of instructions for wireless communication, the set of instructions comprising one or more instructions that, when executed by one or more processors of a device, cause the device to perform the method of one or more of Aspects 9-16.

Aspect 43: An apparatus for wireless communication at a device, comprising a processor; memory coupled with the processor; and instructions stored in the memory and executable by the processor to cause the apparatus to perform the method of one or more of Aspects 17-24.

Aspect 44: A device for wireless communication, comprising a memory and one or more processors coupled to the memory, the one or more processors configured to perform the method of one or more of Aspects 17-24.

Aspect 45: An apparatus for wireless communication, comprising at least one means for performing the method of one or more of Aspects 17-24.

Aspect 46: A non-transitory computer-readable medium storing code for wireless communication, the code comprising instructions executable by a processor to perform the method of one or more of Aspects 17-24.

Aspect 47: A non-transitory computer-readable medium storing a set of instructions for wireless communication, the set of instructions comprising one or more instructions that, when executed by one or more processors of a device, cause the device to perform the method of one or more of Aspects 17-24.

Aspect 48: An apparatus for wireless communication at a device, comprising a processor; memory coupled with the processor; and instructions stored in the memory and executable by the processor to cause the apparatus to perform the method of one or more of Aspects 25-32.

Aspect 49: A device for wireless communication, comprising a memory and one or more processors coupled to the memory, the one or more processors configured to perform the method of one or more of Aspects 25-32.

Aspect 50: An apparatus for wireless communication, comprising at least one means for performing the method of one or more of Aspects 25-32.

Aspect 51: A non-transitory computer-readable medium storing code for wireless communication, the code comprising instructions executable by a processor to perform the method of one or more of Aspects 25-32.

Aspect 52: A non-transitory computer-readable medium storing a set of instructions for wireless communication, the set of instructions comprising one or more instructions that, when executed by one or more processors of a device, cause the device to perform the method of one or more of Aspects 25-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
determine a set of non-zero coefficients (NZCs) that are associated with coherent joint transmission (CJT) and multiple transmit-receive points (TRPs) of a network; and
transmit uplink control information (UCI) indicating at least a portion of the set of NZCs ordered according to an order of the associated TRPs.

2. The apparatus of claim 1, wherein a size of the portion of the set of NZCs is based at least in part on a size of resources for a physical uplink shared channel associated with the UCI.

3. The apparatus of claim 1, wherein the portion of the set of NZCs is ordered according to a natural order of indices of the associated TRPs.

4. The apparatus of claim 1, wherein the UCI includes a strongest coefficient indication, and the portion of the set of NZCs begins with NZCs associated with a TRP, of the TRPs, associated with the strongest coefficient indication.

5. The apparatus of claim 1, wherein the UCI includes a bit sequence indicating the order of the associated TRPs.

6. The apparatus of claim 5, wherein the UCI further includes a strongest coefficient indication, and the bit sequence omits a TRP, of the TRPs, associated with the strongest coefficient indication.

7. The apparatus of claim 1, wherein the portion of the set of NZCs is further ordered according to an order of frequency bases for the set of NZCs.

8. The apparatus of claim 7, wherein the order of the frequency bases for each TRP is based at least in part on a strongest coefficient associated with the TRP.

9. An apparatus for wireless communication at a network entity, comprising:
a memory; and
one or more processors, coupled to the memory, configured to:
receive uplink control information (UCI) indicating at least a portion of a set of non-zero coefficients (NZCs), associated with multiple transmit-receive points (TRPs), ordered according to an order of the associated TRPs; and
perform coherent joint transmission (CJT) precoding based on the portion of the set of NZCs.

10. The apparatus of claim 9, wherein the one or more processors are further configured to:
transmit a grant for a physical uplink shared channel associated with the UCI,
wherein a size of the portion of the set of NZCs is based at least in part on a size of resources associated with the grant.

11. The apparatus of claim 9, wherein the portion of the set of NZCs are ordered according to a natural order of indices of the associated TRPs.

12. The apparatus of claim 9, wherein the UCI includes a strongest coefficient indication, and the portion of the set of NZCs begins with NZCs associated with a TRP, of the TRPs, associated with the strongest coefficient indication.

13. The apparatus of claim 9, wherein the UCI includes a bit sequence indicating the order of the associated TRPs.

14. The apparatus of claim 13, wherein the UCI further includes a strongest coefficient indication, and the bit sequence omits a TRP, of the TRPs, associated with the strongest coefficient indication.

15. The apparatus of claim 9, wherein the portion of the set of NZCs is further ordered according to an order of frequency bases for the set of NZCs.

16. The apparatus of claim 15, wherein the order of the frequency bases for each TRP is based at least in part on a strongest coefficient associated with the TRP.

17. An apparatus for wireless communication at a user equipment (UE), comprising:
a memory; and
one or more processors, coupled to the memory, configured to:
determine a set of non-zero coefficients (NZCs) that are associated with coherent joint transmission (CJT) and multiple transmit-receive points (TRPs) of a network; and
transmit uplink control information (UCI) indicating at least a portion of the set of NZCs ordered according to an order of frequency bases for the set of NZCs.

18. The apparatus of claim 17, wherein a size of the portion of the set of NZCs is based at least in part on a size of resources for a physical uplink shared channel associated with the UCI.

19. The apparatus of claim 17, wherein the portion of the set of NZCs is ordered according to a natural order of indices of the frequency bases.

20. The apparatus of claim 17, wherein the portion of the set of NZCs is ordered according to a permutation of indices of the frequency bases.

21. The apparatus of claim 17, wherein the UCI includes a bit sequence indicating the order of the frequency bases.

22. The apparatus of claim 21, wherein the UCI further includes a strongest coefficient indication, and the bit sequence omits a frequency basis, of the frequency bases, associated with the strongest coefficient indication.

23. The apparatus of claim 17, wherein the portion of the set of NZCs is further ordered according to an order of the associated TRPs.

24. The apparatus of claim 17, wherein the portion of the set of NZCs includes a plurality of subsets, wherein each subset includes a plurality of the frequency bases.

25. An apparatus for wireless communication at a network entity, comprising:
a memory; and
one or more processors, coupled to the memory, configured to:
receive uplink control information (UCI) indicating at least a portion of a set of non-zero coefficients (NZCs), associated with multiple transmit-receive points (TRPs), ordered according to an order of frequency bases for the set of NZCs; and
perform coherent joint transmission (CJT) precoding based on the portion of the set of NZCs.

26. The apparatus of claim 25, wherein the one or more processors are further configured to:
transmit a grant for a physical uplink shared channel associated with the UCI,
wherein a size of the portion of the set of NZCs is based at least in part on a size of resources associated with the grant.

27. The apparatus of claim 25, wherein the portion of the set of NZCs is ordered according to a natural order of indices of the frequency bases.

28. The apparatus of claim 25, wherein the portion of the set of NZCs is ordered according to a permutation of indices of the frequency bases.

29. The apparatus of claim 25, wherein the UCI includes a bit sequence indicating the order of the frequency bases.

30. The apparatus of claim 29, wherein the UCI further includes a strongest coefficient indication, and the bit sequence omits a frequency basis, of the frequency bases, associated with the strongest coefficient indication.

31. The apparatus of claim 25, wherein the portion of the set of NZCs is further ordered according to an order of the associated TRPs.

32. The apparatus of claim 25, wherein the portion of the set of NZCs includes a plurality of subsets, wherein each subset includes a plurality of the frequency bases.
